(19) United States
(12) Patent Application Publication
(10) Pub. No.: US 2025/0060017 A1
(43) Pub. Date: Feb. 20, 2025

(54) SPRING ELEMENT FOR A CUSHION SUPPORT AND ARRANGEMENT WITH SEVERAL SPRING ELEMENTS

(71) Applicant: Froli Kunststoffwerk e.Kfr., Schloß Holte-Stukenbrock (DE)

(72) Inventor: Margret Fromme, Schloß Holte-Stukenbrock (DE)

(21) Appl. No.: 18/805,879

(22) Filed: Aug. 15, 2024

(30) Foreign Application Priority Data
Aug. 17, 2023 (DE) 20 2023 104 680.0

(51) Int. Cl. F16F 3/087; A47C 31/00

(52) U.S. Cl. CPC F16F 3/0876; A47C 31/00

(57) ABSTRACT

A spring element for a cushion support is provided comprising a support plate; bases, each having a fastener for fastening the spring element to a carrier material; and spring arms, each having outer ends which are connected to the support plate and a middle section which includes an associated base of the bases, wherein the spring arms are formed substantially parallel to one another. Furthermore, an arrangement including a plurality of spring elements is provided.

### CROSS-REFERENCE TO RELATED APPLICATIONS

This application claims priority to German Application No. 20 2023 104 680.0, having a filing date of Aug. 17, 2023, the entire contents of which are hereby incorporated by reference.

### FIELD OF TECHNOLOGY

The following relates to a spring element for a cushion support and an arrangement with several spring elements.

### BACKGROUND

Spring elements for a cushion support are used, for example, to produce a flexible cushion support using an arrangement of a large number of spring elements, on which a cushion can then be placed to form a sitting or lying surface. Arrangements with several spring elements are known in which the spring elements are distributed over a surface according to a regular or irregular structure. The spring elements have a base that comes to rest on a support/supporting material when the spring element is mounted, as well as a support plate and spring arms arranged between them. The support plates of the plurality of spring elements together form a support surface for the cushion. Designs are known in which each individual spring element is attached separately to the support/supporting material, for example by a screw or a nail by which the base is attached to the support, which can be a wooden board, for example. Arrangements are also known in which a plurality of spring elements are attached next to one another along a strip in this way.

The document DE 2020 14 104 824 U1, for example, discloses an arrangement of spring elements for a cushion pad, with a plurality of spring elements in which spring arms are arranged between a base and a support plate, wherein the spring elements are arranged next to one another in such a manner that the support plates of the plurality of spring elements together span a support surface.

The spring elements known from the document DE 2020 14 104 824 U1 have a single base with a single fastening means.

### SUMMARY

An aspect relates to a spring element for a cushion support and an arrangement with a plurality of spring elements, which provide improved fastening techniques and lower material requirements.

To solve this problem, a spring element for a cushion support and an arrangement comprising a plurality of spring elements are provided. Further embodiments are described herein.

According to one aspect of embodiments of the invention, a spring element for a cushion support is provided. The spring element comprises: a support plate, bases, each having a fastening means, i.e., a fastener, for fastening the spring element to a carrier material, and spring arms, each having outer ends which are connected to the support plate, and a middle section which comprises an associated base of the bases, wherein the spring arms are formed substantially parallel to one another.

According to a further aspect of embodiments of the invention, an arrangement with a plurality of such spring elements is provided, wherein: the spring elements are arranged next to one another in such a manner that the support plates of the plurality of spring elements together span a support surface, and the spring elements are fastened to the carrier material via the fasteners.

The spring element can have exactly two spring arms. Each of the two spring arms can have exactly one base with exactly one fastener. Alternatively, the spring element can have three, four or more spring arms. The spring arms can be arranged next to one another at equidistant intervals.

The substantially parallel spring arms can be arranged at an angle to each other that is less than 1 degree, for example, less than 0.1 degree, and as a further example, less than 0.01 degree. The spring arms can be formed parallel to each other.

The fastener can be a means, i.e., a structure, by which fastening to the carrier material is made possible. This can be, for example, a through hole. The through hole fastener enables fastening via a screw, a nail and/or a rivet. Screw, nail, rivet or the like are optionally included in the term “fastener” as used here.

The spring element can be arranged in a Cartesian coordinate system with x, y and z axes. The y axis can be arranged parallel to the normal to the surface of the side of the support plate facing away from the bases. In embodiments, the y-axis can point in the same direction as the surface normal of the side of the support plate facing away from the bases. The y-axis can point upwards. A plan view is a view parallel and opposite to the y-axis. In other words, the plan view is a view from above or a view perpendicular to the side of the support plate facing away from the bases. The x-axis can run parallel to the spring arms.

The spring arms can be equal. They can be made of the same material and/or have the same shape. In embodiments, features of a spring arm described here can also be provided for one or more other spring arms.

The bases can be spaced apart from each other. The bases can be arranged at the same height in relation to the support plate. The bases can lie on the same plane, which can be arranged parallel to the xz plane. At this plane/height, the bases can be free of any (material) connection. The bases can be connected to each other only via the spring arms and the support plate. The bases can be free of any direct (material) connection.

The spring arms can also be free of a direct (material) connection. The spring arms can only be connected to each other only via the support plate.

At least one of the spring arms can be curvature-free in a plan view. The spring arms can be arranged parallel to the x-axis. The spring arms can extend substantially over the entire width of the support plate. The connections between the spring arms and the support plate can be formed on an outer edge of the support plate.

At least one of the spring arms can be configured as a leaf spring arm in sections or completely. The spring arms of the spring element can be manufactured with the same spring constant.

At least one of the spring arms can form a convex arc in relation to the support plate. The spring arm can curve downwards from the support plate. The base of the spring arm can be the lowest section of the spring arm. The spring arm can be axially symmetric. The spring element can be axially symmetric. In a view perpendicular to the spring arms (parallel to the z-axis—view from the front/back), at least one spring arm can form a convex arc.

The spring element can be formed (integrally) in one piece. Alternatively, the spring elements can be formed in multiple pieces, for example with a plurality of sections that can be put together. The spring element can be manufactured by an injection moulding process. The spring element can be made from an elastomer, for example a thermoplastic elastomer.

At least one of the spring arms can taper in thickness towards the connection to the support plate. The thickness can be the extension of the spring arm in the vertical direction/y-direction. The thickness can be the extension of the spring arm orthogonal to its surface facing towards and/or away from the support plate. The width of the spring arm can be the extension of the spring arm perpendicular to its long side. The width of the spring arm can be the extension of the spring arm in the x-direction. The width of the spring arm can be substantially constant along its entire length. The width of the spring arm can increase only at the outer ends of the spring arm. The width of the spring arm can be greater than the thickness. In embodiments, the smallest width of the spring arm can be greater than the largest thickness of the spring arm.

At least one of the fasteners can have a fastening hole. The fastening hole can be a through hole. The fastener can be provided in the middle of the spring arm. The fastening hole can be configured to fasten the spring element to a carrier material by a screw, nail and/or rivet. A depression/recess in the base can be provided around the fastening hole. The depression/recess can be configured as a counterbore for a screw, nail and/or rivet head. Alternatively, a differently shaped depression/recess can be provided in the base, for example with a size that allows the use of an actuating tool for a fastener within the depression/recess. As a further alternative, both a counterbore and a larger depression/recess can be provided, for example, a counterbore for a screw, nail and/or rivet head within a larger depression/recess, for example at the bottom thereof.

The support plate can have openings. The openings can be arranged parallel to the spring arms. The openings can have a substantially constant width along their long side. The openings can extend substantially along the entire width of the support plate, with narrow bridges remaining on the edge of the support plate such that the support plate is not penetrated by the openings. The support plate can have two openings. Additionally or alternatively, the support plate can have further openings. The further openings can be smaller, for example, in terms of their area more than twice, three times, five times or ten times smaller than the openings. The further openings can be enclosed/comprised by the transverse webs.

The support plate can have stiffening ribs. The stiffening ribs can increase the stiffness (e.g., torsional stiffness) of the support plate. In areas of the stiffening ribs, the thickness of the support plate can be greater than in adjacent areas of the support plate. The thickness of the support plate can be the extension of the support plate perpendicular to the side of the support plate facing towards or facing away from the bases. The thickness of the support plate can be the extension of the support plate in the y direction.

The support plate can have a rectangular, for example, square, external shape in embodiments. The corners can be rounded. The support plate can have a concave external shape. The support plate can be continuous. The support plate can have a concave peripheral edge that is continuously formed from a material. The surface of the support plate facing away from the bases can lie in one plane.

In a plan view, the spring arms can be arranged in the openings without overlapping. In a plan view, the spring arms can be arranged completely in the openings. Herein, in a plan view, the support plate is free of sections that cover the spring arms.

This allows the spring element to be compressed in such a manner that the bases and the support plate are on the same level. The spring element therefore has a high degree of utilization. Thereby, flat arrangements with such spring elements as a cushion support are possible.

When viewed from above (plan view), gaps can be formed between at least one of the spring elements and the edges of the associated opening. In the area of a gap, the gap width can be substantially constant.

The support plate can have outer edge webs and transverse webs that connect these edge webs to one another. The edge webs can be arranged perpendicular to the transverse webs. The openings can be arranged between the transverse webs. The spring element can comprise three transverse webs and two edge webs. The middle transverse web of the three transverse webs can be wider than the outer transverse webs. The edge webs and/or transverse webs can run substantially horizontally.

The spring arms can be connected to the support plate via the edge webs. The edge webs can alternately comprise a connection to a transverse web and a connection to a spring arm, wherein connections to transverse webs can be provided at the end.

The spring arms and the transverse webs can be arranged substantially parallel to each other in a plan view.

The transverse webs can be connected to the edge webs in such a manner that the edge webs can be displaced relative to one another. The connection between at least one of the edge webs and at least one of the transverse webs can change from a first state to a second state in an elastically reversible manner under load, for example tensile load, wherein in the second state the distance between the at least one edge web and the at least one transverse web is greater than in the first state. This connection can contribute to a significant part of the spring effect of the spring element. The connection between at least one of the edge webs and at least one of the transverse webs can have a U-shape.

The transverse webs and the spring arms can be non-overlapping in a plan view.

The spring elements can be attached to the carrier material by screws and/or rivets.

The arrangement can be a cushion support. The cushion support can have a plurality of spring elements attached to a carrier material, the spring elements being connected to one another via the carrier material in such a manner that the spring elements are fixed in their relative position to one another. In the arrangement, spring elements can be combined with one another in which the spring arms have different spring constants. The spring elements can be freely mounted on the carrier material. Since the spring element has at least two bases with associated fasteners, the spring element can be mounted in a rotationally fixed manner.

The term “substantially”, as for example in the statement that the spring arms and the transverse webs can be arranged substantially parallel to one another in a plan view, can be omitted here in such a manner that the statement following such term is then precise, which can include error limits. The spring arms and the transverse webs can therefore be arranged parallel to one another in a plan view.

In connection with the arrangement, the embodiments described above in connection with the spring element can be provided accordingly and vice versa.

### BRIEF DESCRIPTION

Some of the embodiments will be described in detail, with references to the following Figures, wherein like designations denote like members, wherein:

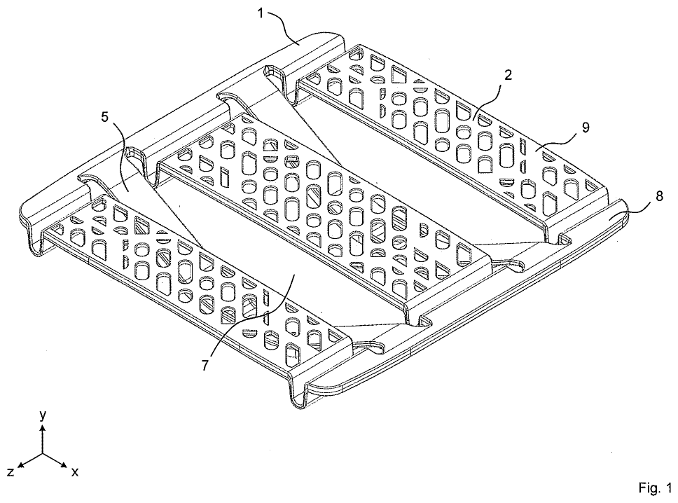

FIG. 1 shows a schematic representation of a spring element for a cushion support according to embodiments;

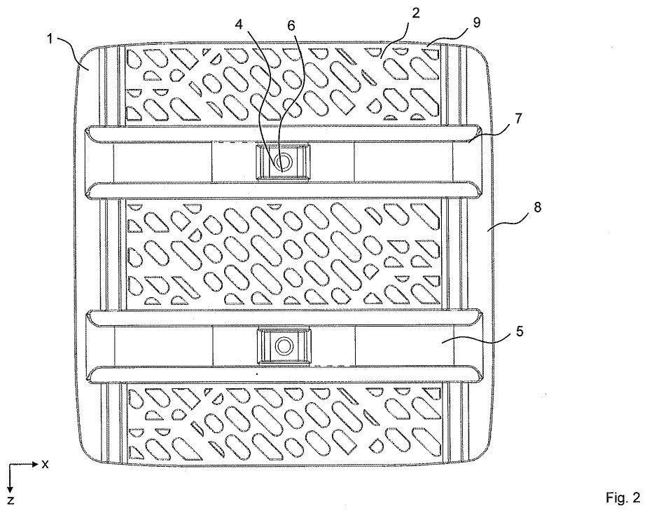

FIG. 2 shows a perspective view of the spring element from FIG. 1 from above;

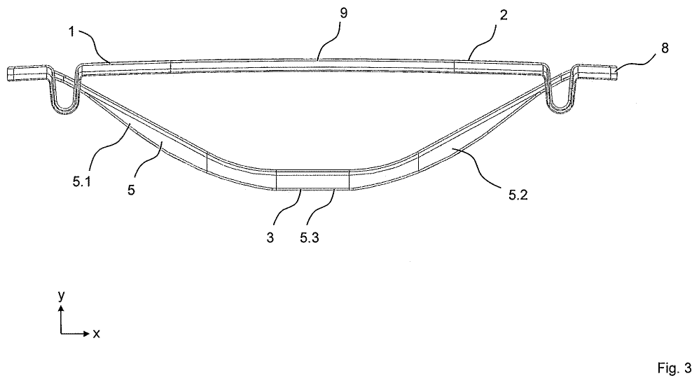

FIG. 3 shows a perspective view of the spring element from FIG. 1 from the front;

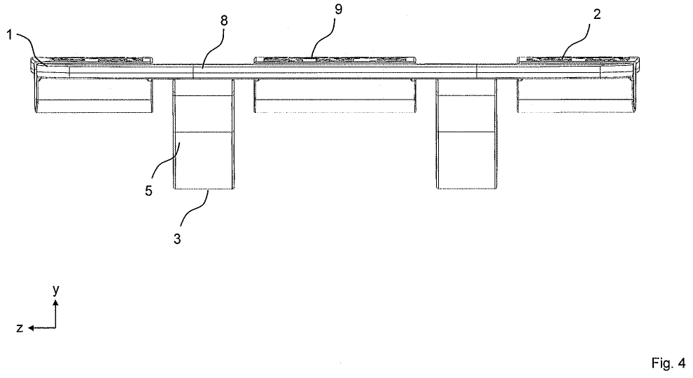

FIG. 4 shows a perspective view of the spring element from FIG. 1 from the side;

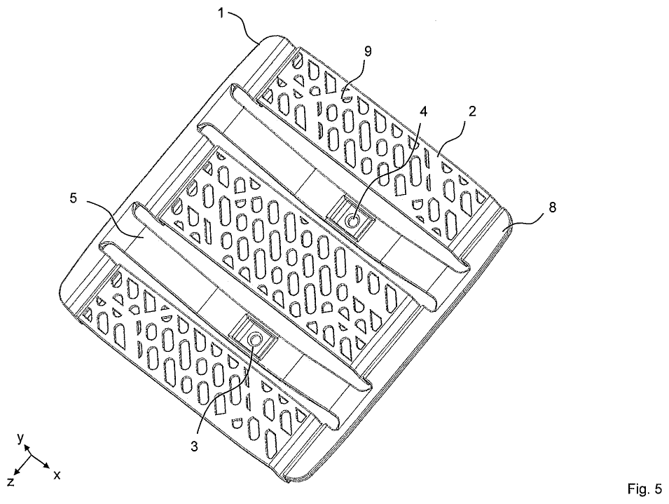

FIG. 5 shows a perspective view of the spring element from FIG. 1 from obliquely above;

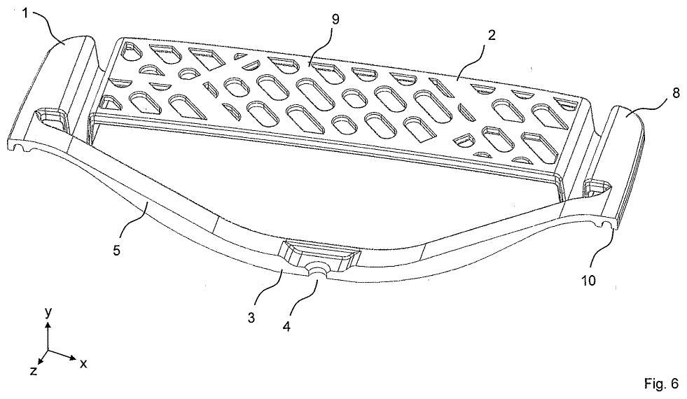

FIG. 6 shows a sectional view of the spring element from FIG. 1 with a longitudinal section through one of the spring arms;

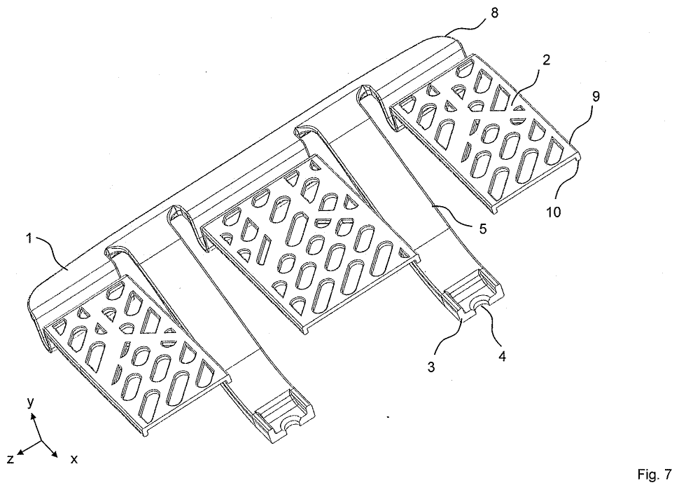

FIG. 7 shows a sectional view of the spring element from FIG. 1 with a section perpendicular to the spring arms centrally through the spring element;

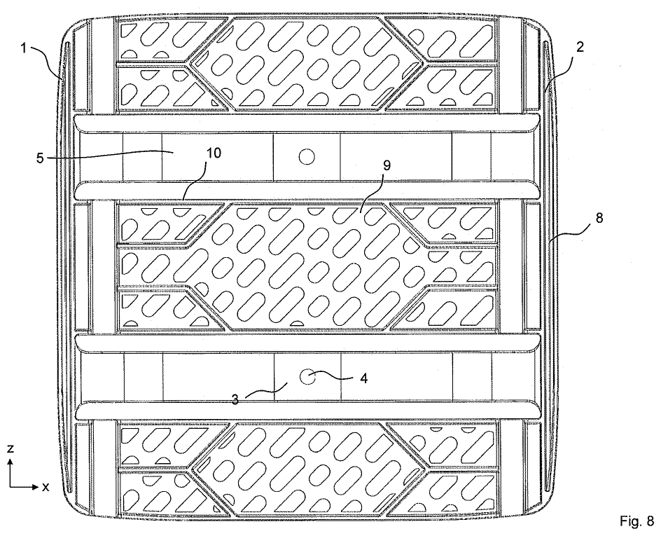

FIG. 8 shows a perspective view of the spring element from FIG. 1 from below;

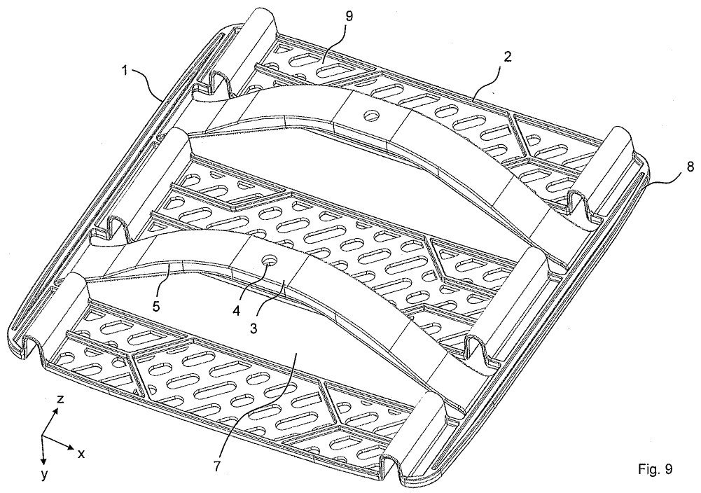

FIG. 9 shows a perspective view of the spring element from FIG. 1 from obliquely below; and

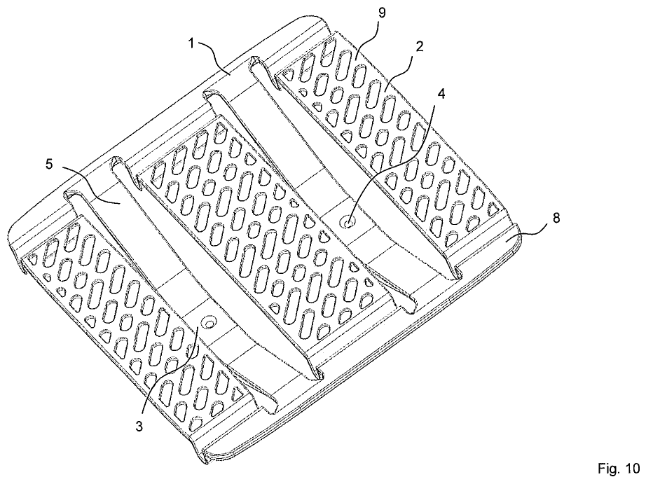

FIG. 10 shows a perspective view of an alternative embodiment of a spring element.

### DETAILED DESCRIPTION

FIG. 1 shows a schematic representation of a spring element 1 for a cushion support. FIGS. 2 to 5 and 8 and 9 show perspective representations of the spring element 1 from FIG. 1 from different directions.

The spring element 1 comprises a support plate 2, bases 3, each having a fasteners 4 for fastening the spring element 1 to a carrier material, and spring arms, each having outer ends 5.1, 5.2 which are connected to the support plate 2, and a middle section 5.3 which comprises an associated base 3 of the bases 3, wherein the spring arms 5 are formed parallel to one another.

In the embodiment shown, the spring element 1 has two spring arms 5 with two bases 3. The bases are free of a direct (material) connection. The middle sections 5.3 of the spring arms 5 are free of a direct (material) connection. The spring arms 5 are only connected to one another via the support plate 2.

In the embodiment shown, the spring element 1 is formed in one piece/integral.

The support plate 2 of the spring element of the embodiment shown comprises outer edge webs 8 and transverse webs 9 which connect these edge webs 8 to one another. More precisely, the support plate 2 comprises two edge webs 8 and three transverse webs 9. The transverse webs 9 are arranged between the edge webs 8 and perpendicular to them. A first transverse web 9 of the transverse webs 9 is moulded with a first end (in one piece) onto a first end of the first edge web 8 of the edge webs 8 and with a second end (in one piece) onto a first end of the second edge web 8 of the edge webs 8. A second transverse web 9 of the transverse webs 9 is moulded with a first end (in one piece) onto a second end of the first edge web 8 of the edge webs 8 and with a second end (in one piece) onto a second end of the second edge web 8 of the edge webs 8. A third transverse web 9 of the transverse webs 9 is moulded with a first end (in one piece) centrally on the first edge web 8 of the edge webs 8 and with a second end (in one piece) centrally on the second edge web 8 of the edge webs 8. The support plate 2 has openings 7 between the transverse webs 9. The edge webs 8 have sections that comprise a connection to a transverse web 9 and sections that are free of a connection to a transverse web 9.

The transverse webs 9 have further openings. The edge webs 8 are free of openings. The transverse webs 9 and the edge webs 8 lie substantially in one plane.

The underside of the support plate 2 has stiffening ribs 10 (see FIG. 8). The stiffening ribs 10 are configured to increase the stiffness of the support plate 2. The stiffening ribs 10 are narrow, elongated areas of the support plate 2 with increased thickness. Along the edge webs 8, the stiffening ribs 10 run substantially in the longitudinal direction of the edge webs 8. The edge webs have stiffening ribs 10 that extend substantially over the entire length of the edge webs 8. The transverse webs 9 have stiffening ribs 10 that extend parallel to the longitudinal direction of the transverse webs 9. In addition, the transverse webs 9 have stiffening ribs 10 that extend obliquely to the longitudinal direction of the transverse webs 9. The stiffening ribs 10, which extend parallel to the longitudinal direction of the transverse webs 9, extend substantially over the entire length of the transverse webs 9 and are arranged along the long outer edge of the transverse webs 9.

In a plan view, the spring arms 5 are arranged in the openings 7 between the transverse webs 9. The spring arms 5 are moulded (in one piece) onto the edge webs 8. The respective spring arms 5 are moulded with a first end onto the first edge web 8 and with a second end onto the second edge web 8. The spring arms 5 are moulded onto the edge web 8 where the edge webs 8 are free of a connection to the transverse webs 9. The spring arms 5 are moulded onto the edge webs 8 where the openings 7 border the edge webs 8. In a plan view, the edge webs 8 are alternately connected by transverse webs 9 and spring arms 5, with transverse webs 9 being provided on the outside. Gaps are provided between these connections. In a plan view, the transverse webs 9 have a substantially constant width. This also applies to the spring arms 5, wherein these have a widening at the end where they are connected to the edge webs 8.

The spring arms 5 are formed to be concave in relation to the support plate 2. The two ends of the spring arms 5 are moulded onto the support plate 2 and the bases 3 of the spring arm 5 are spaced from the support plate 2. The bases 3 are arranged below the support plate 2. The spring arms 5 can have a first curvature and a second curvature that is different from the first curvature and/or opposite to the first curvature. In the area of the bases 3, the spring arms 5 are curvature-free. Starting from the bases 3, the spring arms 5 can initially curve towards the support plate 2 and then curve away from the support plate 2 at the end. At the points where the spring arms 5 are moulded onto the edge webs 8, the edge webs 8 have constrictions.

At the connection points between the transverse webs 9 and the edge webs 8, the spring element 1 has U-shaped connecting bridges. The U-shaped connecting bridges are elastically reversibly deformable, so that the edge webs 8 can move away from one another and/or towards one another in a direction parallel to the transverse webs 9. This deformability contributes to the spring effect of the spring element 1. In embodiments, this deformability can make up the substantial part of the spring effect of the spring element 1. In this case, the other elements of the spring element 1 are substantially rigid.

FIG. 6 shows a sectional view of the spring element 1 from FIG. 1 with a longitudinal section through one of the spring arms 5. FIG. 7 shows a sectional view of the spring element 1 from FIG. 1 with a section perpendicular to the spring arms centrally through the spring element. The thickness of the spring arm 5 tapers from the base 3 to the connection with the support plate 2. The base 3 comprises a fastening hole as a fastener 4. On the side of the base 3 that faces the support plate 2, the spring arm 5 has a recess/depression around the fastening hole. The spring element 1 can be fastened to a carrier material via the fastening holes. For example, the spring element 1 can be screwed onto the carrier material with screws that are guided through the fastening holes. The screw head can be countersunk into the recess/depression, for example, in such a manner that it is not visible when viewed from the front. In the embodiment shown, the recess/depression has a counterbore for a screw head at the bottom of a larger recess/depression, which enables the use of a tool for fastening a disk within the recess/depression. In alternative embodiments, only one counterbore for a screw head (or head of another fastener) or only one larger recess/depression can be provided. An embodiment with only one counterbore for a screw head is shown as an example in FIG. 10.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A spring element for a cushion support, comprising:
a support plate;
bases, each base having a fastener for fastening the spring element to a carrier material; and
spring arms, each spring arm having outer ends which are connected to the support plate, and a central section which comprises an associated base of the bases, wherein the spring arms are formed substantially parallel to one another.

2. The spring element according to claim 1, wherein the bases are spaced apart from one another.

3. The spring element according to claim 1, wherein in a plan view at least one of the spring arms is free of curvature.

4. The spring element according to claim 1, wherein at least one of the spring arms forms a convex arc with respect to the support plate.

5. The spring element according to claim 1, wherein the spring element is formed integrally in one piece.

6. The spring element according to claim 1, wherein at least one of the spring arms tapers in thickness towards the connection to the support plate.

7. The spring element according to claim 1, wherein at least one of the fasteners has a fastening hole.

8. The spring element according to claim 1, wherein the support plate has openings.

9. The spring element according to claim 8, wherein in a plan view the spring arms are arranged in the openings without overlap.

10. The spring element according to claim 1, wherein the support plate has outer edge webs and transverse webs, wherein the transverse webs connect the edge webs to one another.

11. The spring element according to claim 10, wherein the spring arms are connected to the support plate via the edge webs.

12. The spring element according to claim 10, wherein the spring arms and the transverse webs are arranged substantially parallel to one another in a plan view.

13. The spring element according to claim 10, wherein the transverse webs are connected to the edge webs such that the edge webs are displaceable relative to one another.

14. The spring element according to claim 10, wherein in a plan view the transverse webs and the spring arms are free of overlap.

15. An arrangement comprising a plurality of spring elements, each of the plurality of spring elements according to claim 1, wherein
the spring elements are arranged next to one another such that the support plates of the plurality of spring elements together span a support surface; and
the spring elements are attached to the carrier material via the fasteners.

16. The arrangement according to claim 15, wherein the spring elements are fastened to the carrier material by screws and/or rivets.
